(19) United States
(12) Patent Application Publication
(10) Pub. No.: US 2013/0343704 A1
(43) Pub. Date: Dec. 26, 2013

(54) COMPACT MODE-SIZE TRANSITION USING A FOCUSING REFLECTOR

(71) Applicant: ACACIA COMMUNICATIONS INC., Maynard, MA (US)

(72) Inventor: Christopher DOERR, MAYNARD, MA (US)

(21) Appl. No.: 13/928,014

(22) Filed: Jun. 26, 2013

Related U.S. Application Data
(60) Provisional application No. 61/664,609, filed on Jun. 26, 2012.

(51) Int. Cl. G02B 6/34; G02B 6/26

(52) U.S. Cl. CPC G02B 6/34; G02B 6/26
USPC 385/37; 385/31

(57) ABSTRACT

Disclosed herein are techniques, methods, structures and apparatus for optically coupling optical waveguides and optical structures exhibiting different widths in which In which a focusing reflector is used to optically couple a relatively wide optical waveguide to a relatively narrow optical waveguide. An exemplary method according to the present disclosure comprises the steps of: providing the first waveguide that is 5 or more wavelengths in width; providing the second waveguide that is 3 or less wavelengths in width; coupling light emanating from the first waveguide to the second waveguide through the effect of a slab waveguide having a curved edge.

### CROSS REFERENCE TO RELATED APPLICATIONS

This application claims the benefit of U.S. Provisional Patent Application Ser. No. 61/664,609 filed Jun. 26, 2012 which is incorporated by reference in its entirety as if set forth at length herein.

### TECHNICAL FIELD

This disclosure relates generally to the field of optical communications and in particular to techniques, methods and apparatus for optically coupling optical waveguides using a focusing reflector. More specifically, this disclosure pertains to the optical of a relatively wide waveguide to a relatively narrower waveguide in a compact manner using a focusing reflector.

### BACKGROUND

Contemporary optical communications and other systems oftentimes require the optical coupling of one optical waveguide to another optical waveguide—or to another optical structure such as an optical grating. Frequently such optical waveguides and structures do not exhibit the same width—consequently a compact and efficient transition is required. Accordingly, methods, structures or techniques that facilitate the optical coupling of optical waveguides and optical structures exhibiting different widths would represent a welcome addition to the art.

### SUMMARY

An advance in the art is made according to an aspect of the present disclosure directed to techniques, methods and apparatus for optically coupling optical waveguides and optical structures exhibiting different widths.

In an exemplary embodiment and according to an aspect of the present disclosure, a focusing reflector is used to optically couple a relatively wide optical waveguide to a relatively narrow optical waveguide. An exemplary method according to the present disclosure comprises the steps of: providing the first waveguide that is 5 or more wavelengths in width; providing the second waveguide that is 3 or less wavelengths in width; coupling light emanating from the first waveguide to the second waveguide through the effect of a slab waveguide having a curved edge.

In another exemplary embodiment according to another aspect of the present disclosure, a focusing reflector is used to optically couple a 1-D grating coupler to an optical waveguide.

In yet another exemplary embodiment according to yet another aspect of the present disclosure, a focusing reflector is used to optically couple a 2-D grating coupler to a number of optical waveguides.

Advantageously, such coupling according to the present disclosure result in compact structures exhibiting low insertion loss, low wavelength dependence, low scattered light and does not require modifications to other elements such as grating couplers.

### BRIEF DESCRIPTION OF THE DRAWING

A more complete understanding of the present disclosure may be realized by reference to the accompanying drawings in which:

FIG. 1 shows a schematic top-view of a relatively wide optical waveguide optically coupled to a relatively narrow optical waveguide through the effect of a focusing reflector according to an aspect of the present disclosure;

FIG. 2 shows a schematic top-view of a 1-D optical grating coupler optically coupled to a narrow optical waveguide through the effect of a focusing reflector according to an aspect of the present disclosure; and

FIG. 3 shows a schematic layout configuration of a 2-D optical grating coupler optically coupled to a number of optical waveguides through the effect of a focusing reflector according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is noted that oftentimes when designing a photonic integrated circuits (PIC), one needs to optically couple a relatively wide optical waveguide to a relatively narrow optical waveguide in as short a distance as possible. An example of this coupling is the transitioning from a grating coupler to a single-mode silicon wire optical waveguide. As is known, grating couplers are 1- or 2-D photonic crystals that optically couple light from an in-plane optical waveguide in a photonic integrated circuit to an out-of-plane optical fiber. To match the fiber mode size, the grating coupler dimensions are typically on the order of 8 μm×8 μm, whereas a silicon wire waveguide is typically only 0.8 μm wide.

As is further known, a mode-size transition is oftentimes performed by an adiabatic taper, which is a waveguide with a gradual changing width from that of the wide to that of the narrow waveguide. When the wide waveguide is wider than about 5 wavelengths (where wavelength is defined as the wavelength in the waveguide, i.e., free-space wavelength divided by effective refractive index) and the narrow waveguide is narrower than about 2 wavelengths, the taper takes significant real estate on the PIC.

Prior art attempts to make the transition more compact (See, e.g, B. Luyssaert and P. Vandersteegen, “A Compact Photonic Horizontal Spot-Size Converter Realized in Silicon-On-Insulator”, IEEE Photonics Technology Letters, vol. 17, no. 1, pp. 73-75, 2005). Such attempts exhibit low efficiency and significant wavelength dependence. Alternative attempts employ integrated lens(es) in the waveguide (See., e.g., K. V. Acoleyen and R. Baets, “Compact Lens-Assisted Focusing Tapers Fabricated on Silicon-On-Insulator”, IV Photonics (GFP), 2001, 8^{th} IEEE, pp. 7-9, 2011). Such alternative attempts unfortunately result in scattering and reflections at abrupt transition interfaces.

When grating couplers are employed, another alternative attempt employs a focusing grating coupler. (See., e.g., F. V. Laere, W. Bogaerts, and P. Dumon, “Focusing Polarization Diversity Grating Couplers in Silicon-On-Insulator”, Journal of Lightwave, vol. 27, no. 5, pp. 612-618, 2009.) In a focusing grating coupler, the grating elements follow curved lines such that a wavefront is curved laterally in the waveguide after exiting the grating coupler, causing light to focus. However, focusing grating couplers can focus only one side of the grating coupler.

As may be further appreciated, in many situations, it is desired that light be coupled to more than one side (both) of a grating coupler—for example—a grating coupler excited by a non-tilted fiber typically has light exit both sides of the grating coupler. Such configurations may provide higher efficiency and wider bandwidth. (See., e.g, C. Doerr, L. Buhl, Y. Baeyens, R. Aroca, S. Chandrasekhar, X. Liu, L. Chen and Y. Chen, “Packaged Monolithic Silicon 112-Gb/s Coherent Receiver”, Photonics Technology Letters, IEEE, vol. 23, no. 99, pp. 1-1, 2011).

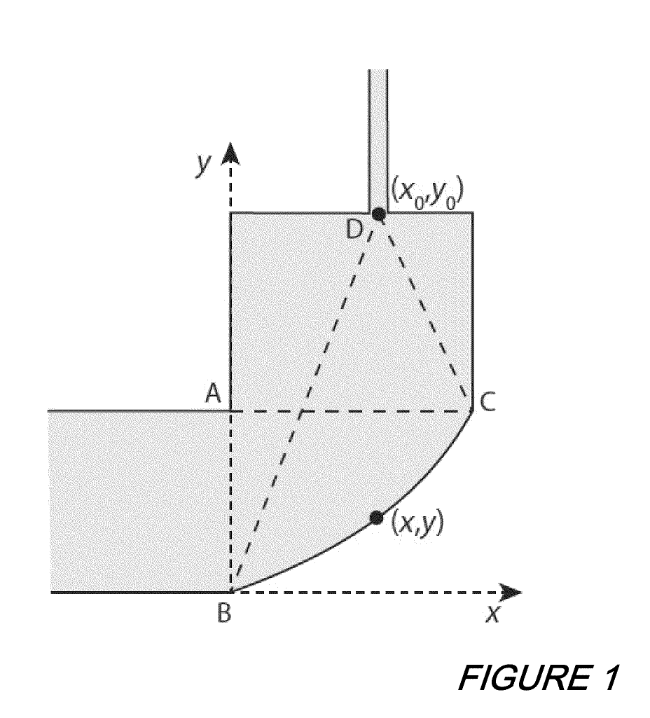

Techniques, methods and apparatus according to one or more aspects of the present disclosure employ a curved, focusing reflector that focuses and redirects light output from a relatively wide optical waveguide into a relatively narrower optical waveguide. Such structures are shown schematically in FIG. 1.

Turning now to FIG. 1, there is shown a schematic top-view of a structure according to the present disclosure wherein a relatively wide waveguide (left) and relatively narrow waveguide (top) are optically coupled together through the effect of a curved reflector. Advantageously, the structures shown in FIG. 1 are fabricated from any of a variety of known waveguide core material.

As shown in FIG. 1, the curved reflector (mirror) is formed from waveguide material having a sidewall appropriately shaped. In order for the reflector to focus, the total path length from a waveguide inlet (relatively narrow waveguide, top), reflecting off the mirror and impinging on the relatively wider waveguide, must be the same for all light rays. Particular examples paths are shown as dotted lines in FIG. 1. The particular example depicted in FIG. 1 shows length ACD equal to length BD.

Equation 1 identifies the set of points that define the shape of the curved, focusing reflector. More specifically:

$$y = {y}_{0} - \sqrt{{y}_{0}^{2} + 2 x ( {x}_{0} - \sqrt{{x}_{0}^{2} + {y}_{0}^{2}} )} \qquad [ 1 ]$$

The origin of the x, y coordinate system is the point on the reflector closest to the relatively wide waveguide (or grating in such configurations). In FIG. 1, that origin point is point “B” on the figure. The location of the waveguide inlet is shown as (x₀, y₀) and the set of (x, y) define the shape of the curved surface of the reflector.

Importantly, the narrow waveguide (top of FIG. 1) inlet width must be chosen so as to match the mode shape of the wider waveguide, which will depend upon the focal length, which is approximately proportional to y₀. Stray reflections off non-intentional-guiding and non-intentional-reflecting waveguide walls can cause extra losses, and therefore such waveguide walls should be positioned as far from the lightwave path as possible.

The maximum angle of all lightwaves striking the reflector with respect to the local reflector normal must be less than the critical angle for maximum efficiency. This is represented by Equation 2 as follows:

$${y}_{0} > {x}_{0} tan ( 2 {sin}^{- 1} \frac{{η}_{clad}}{{η}_{wg}} ) \qquad [ 2 ]$$

where η_{wg} is the effective waveguide refractive index and η_{clad} is the cladding refractive index.

As generally shown in the Figures, the angle of the waveguide with respect to the wider waveguide (grating) is 90 degrees, but it could be a different angle. In such a case Equations 1 and 2 would change, but the requirement that the path length from the waveguide inlet to the reflector to the line normal to wide waveguide axis is remains.

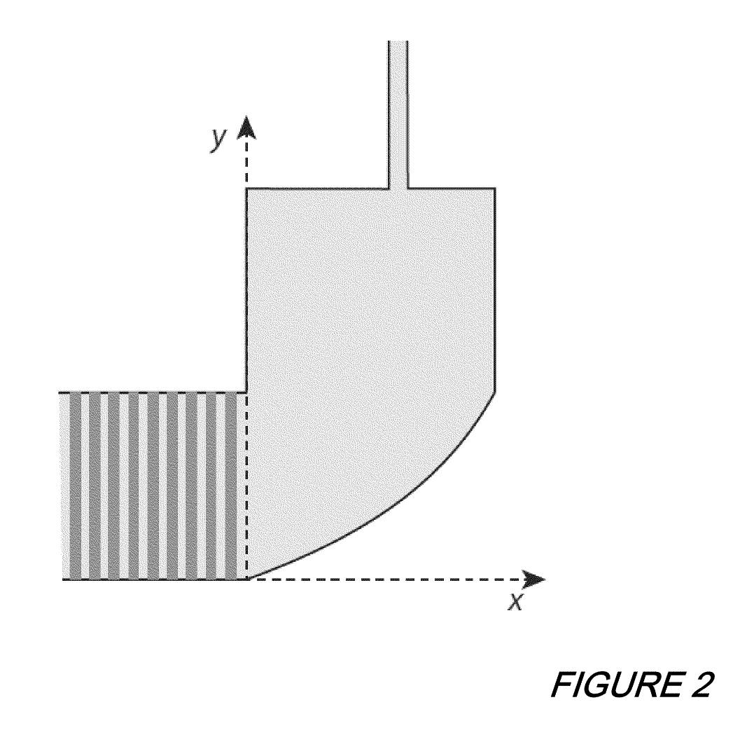

With reference now to FIG. 2, there is shown a schematic top-view of a 1-D grating coupler optically coupled to a relatively narrow waveguide through the effect of a curved reflector (mirror) according to another aspect of the present disclosure. As depicted in the figure, the grating is shown to the left, the narrower waveguide is shown at top, and the curved focusing reflector is shown interposed between the two. While not specifically shown, the focusing reflector does not have to be directly adjacent to the grating coupler. There may be a finite-length, wide-width waveguide section between the grating and the curved reflector. Still further, more than one side of the grating may be connected to a curved, focusing reflector.

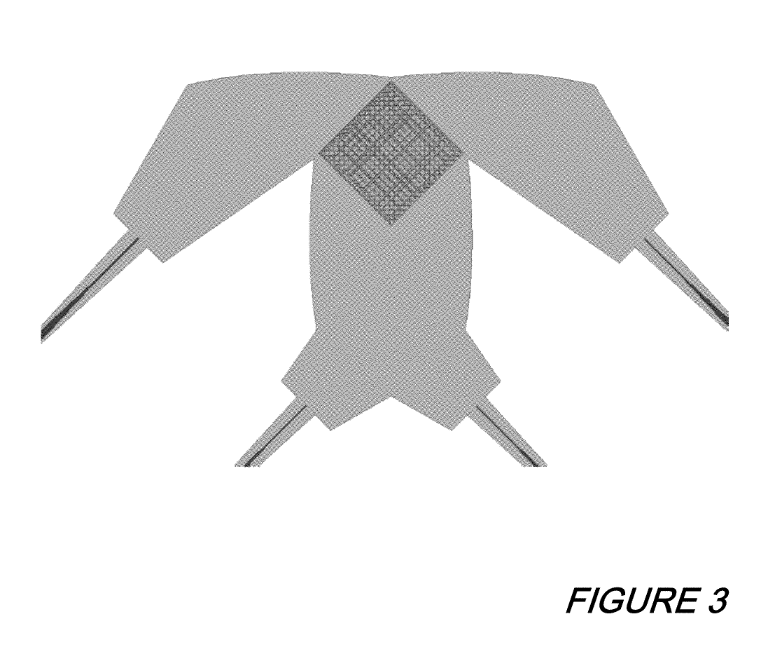

Additionally, in those applications employing a 2-D grating coupler such as those employing non-tilted fiber impinging onto it, light may exit all four sides of the grating. In such an application, one can place focusing reflectors on all four sides as depicted schematically in FIG. 3. With reference to FIG. 3, it may be observed that by making y₀ sufficiently long, one can avoid two waveguide crossings and instead have the light beams cross harmlessly in the focusing region of the curved focusing reflector.

Those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A method of optically coupling a first waveguide to a second waveguide comprising the steps of:
providing the first waveguide that is 5 or more wavelengths in width;
providing the second waveguide that is 3 or less wavelengths in width;
coupling light emanating from the first waveguide to the second waveguide through the effect of a slab waveguide having a curved edge.

2. The method according to claim 1 wherein said first waveguide comprises an optical grating.

3. The method according to claim 1 wherein said first waveguide comprises a 2-D optical grating and said slab waveguide comprises a plurality of curved edges, one for each of the edges of the 2-D optical grating.

4. The method according to claim 1 wherein said curved edge of the slab waveguide is defined by:
$$y = {y}_{0} - \sqrt{{y}_{0}^{2} + 2 x ( {x}_{0} - \sqrt{{x}_{0}^{2} + {y}_{0}^{2}} )}$$
where x, y represents the origin of the coordinate system and is the point on the reflector closest to the first waveguide and the second waveguide inlet is represented by (x₀, y₀) and the set of (x, y) define the shape of the curved edge.

5. The method according to claim 4 wherein the maximum maximum angle of all lightwaves striking the curved edge with respect to a local normal is less than a critical angle and defined by:
$${y}_{0} > {x}_{0} tan ( 2 {sin}^{- 1} \frac{{η}_{clad}}{{η}_{wg}} )$$
where η_{wg} is the effective waveguide refractive index and η_{clad} is the cladding refractive index.

6. A apparatus that optically couples a first waveguide to a second waveguide comprising:
the first waveguide that is 5 or more wavelengths in width;
the second waveguide that is 3 or less wavelengths in width;
a slab waveguide having a curved edge interposed between the first waveguide and the second waveguide and configured such that light emanating from the first waveguide is coupled to the second waveguide through the effect of the curved edge.

7. The apparatus according to claim 6 wherein said first waveguide comprises an optical grating.

8. The apparatus according to claim 6 wherein said first waveguide comprises a 2-D optical grating and said slab waveguide comprises a plurality of curved edges, one for each of the edges of the 2-D optical grating.

9. The apparatus according to claim 6 wherein said curved edge of the slab waveguide is defined by:
$$y = {y}_{0} - \sqrt{{y}_{0}^{2} + 2 x ( {x}_{0} - \sqrt{{x}_{0}^{2} + {y}_{0}^{2}} )}$$
where x, y represents the origin of the coordinate system and is the point on the reflector closest to the first waveguide and the second waveguide inlet is represented by (x₀, y₀) and the set of (x, y) define the shape of the curved edge.

10. The apparatus according to claim 9 wherein the maximum maximum angle of all lightwaves striking the curved edge with respect to a local normal is less than a critical angle and defined by:
$${y}_{0} > {x}_{0} tan ( 2 {sin}^{- 1} \frac{{η}_{clad}}{{η}_{wg}} )$$
where η_{wg} is the effective waveguide refractive index and η_{clad} is the cladding refractive index.

11. A method of optically coupling an optical grating to an optical waveguide comprising the steps of:
coupling light emanating from the optical grating to the optical waveguide through the effect of a slab waveguide having a curved edge.

12. The method according to claim 11 wherein the side of the grating emitting the light exhibits a width that is 5 or more wavelengths in width and the optical waveguide exhibits a width that is 3 or less wavelengths in width wherein said width dimension is measured at the point where the light is emitted and received, respectively.

13. The method according to claim 11 wherein said grating is a 2-D optical grating and said slab waveguide comprises a plurality of curved edges, one for each of the edges of the 2-D optical grating, and the optical waveguide is one of a plurality of waveguides optically connected to a respective side of the 2-D grating by the effect of a respective curved edge.

14. The method according to claim 1 wherein a curved edge of the slab waveguide is defined by:
$$y = {y}_{0} - \sqrt{{y}_{0}^{2} + 2 x ( {x}_{0} - \sqrt{{x}_{0}^{2} + {y}_{0}^{2}} )}$$
where x, y represents the origin of the coordinate system and is the point on the reflector closest to the first waveguide and the second waveguide inlet is represented by (x₀, y₀) and the set of (x, y) define the shape of the curved edge.

15. The method according to claim 14 wherein the maximum angle of all lightwaves striking the curved edge with respect to a local normal is less than a critical angle and defined by:
$${y}_{0} > {x}_{0} tan ( 2 {sin}^{- 1} \frac{{η}_{clad}}{{η}_{wg}} )$$
where η_{wg} is the effective waveguide refractive index and η_{clad} is the cladding refractive index.
